(19) United States
(12) Patent Application Publication
(10) Pub. No.: US 2012/0306718 A1
(43) Pub. Date: Dec. 6, 2012

(54) ANTENNA AND WIRELESS MOBILE TERMINAL EQUIPPED WITH THE SAME

(75) Inventors: Yoshio Koyanagi, Kanagawa (JP); Hiroshi Satou, Kanagawa (JP); Tomoaki Nishikido, Ishikawa (JP)

(73) Assignee: PANASONIC CORPORATION, Osaka (JP)

(21) Appl. No.: 13/576,271

(22) PCT Filed: Feb. 18, 2011
(86) PCT No.: PCT/JP2011/000928

§ 371 Date: Jul. 31, 2012

(30) Foreign Application Priority Data
Feb. 19, 2010 (JP) 2010-034463

(51) Int. Cl. H01Q 1/52

(52) U.S. Cl. 343/853

(57) ABSTRACT

A first connection circuit (108) is controlled so as to cancel mutual coupling impedance existing between a first antenna element (106) and a second antenna element (107) at a first frequency band, thereby lessening deterioration of coupling between the antenna elements. A second connection circuit (111) is controlled so as to cancel mutual coupling impedance existing between a first passive element (109) and a second passive element (110) at a second frequency band, thereby lessening deterioration of coupling between the passive elements. By means of the configuration, it is possible to implement a low-coupling antenna that operates at two frequency bands in a wireless mobile terminal.

### TECHNICAL FIELD

The present invention relates to an arrayed antenna for use with a mobile terminal and is intended for implementing a multi-band arrayed antenna by use of a passive element.

### BACKGROUND ART

Wireless mobile terminals, like cellular phones, are expanding in functionality, like a short-distance wireless communication function, a wireless LAN function, a GPS function, a TV watching function, and an IC card payment function, as well as a phone function, an e-mail function, and a function for making an access to the Internet. In addition, cellular communication is scheduled to employ a MIMO (Multi-Input Multi-Output) technique for effecting a communication by use of a plurality of transmission-side antennas and receiving-side antennas as a technique for realizing a high-speed, large-capacity wireless communication system. MIMO is carried out by transmitting the same space-time coded signals at the same band and from a plurality of transmission antennas, and the signals are received by a plurality of receiving antennas and separated, whereby information is extracted. This makes it possible to increase a transfer rate and carry out high-capacity communication. There is a tendency toward an increase in the number of antennas built into the wireless mobile terminal in accordance with greater functionality. Deterioration of antenna performance stemming from a coupling among the plurality of antenna elements raises a serious problem.

In the meantime, a quantum leap in the number of cellular phone users raises a problem of deficiency in the number of frequencies used for communication. Current communication cellular antennas are required to cope with four bands (i.e., a 800 MHz band, a 1.5 GHz band, a 1.7 GHz band, and a 2 GHz band). In order to cope with a wireless system having a plurality of antennas, such as a MIMO system, at the plurality of frequency bands, there has generally been required a complicate configuration for setting a plurality of antenna elements for respective frequencies, setting a feeding path for each of the antenna elements, and switching among the feeding paths with a switch. However, the configuration makes a circuit size of a compact wireless terminal large, and complicate couplings occur among the plurality of antenna elements, which causes a problem of difficulty being posed on the securing of performance.

In light of design properties and portability, demands for smaller sizes and higher integration exist for the wireless mobile terminals. In order to maintain superior antenna characteristics while miniaturization of the antenna is being pursued against the backdrop, various contrivances must be made to the layout of the antenna elements and the coupling among the antenna elements. Moreover, a high-performance multi-band arrayed antenna system that has the minimum number of feeding paths and antenna elements and measures against coupling deterioration is sought.

As described in connection with; for instance, Patent Document 1 and Non-Patent Document 1, a configuration hitherto known as a related-art wireless mobile terminal addressing such a problem related to a coupling among the antenna elements realizes a low correlation among the antennas by inserting a connection circuit so as to connect together feeding sections of arrayed antenna elements, thereby canceling mutual coupling impedance among the antennas.

Further, as described in connection with Patent Document 2, a configuration hitherto known as means for realizing a multi-band arrayed antenna system includes closely laying an earth element among antennas, to thus cause multiple resonances.

Furthermore, as described in connection with Patent Document 3, a configuration hitherto known as low-coupling means using an earth includes laying an earth line among antennas, to thus realize low coupling.

### RELATED ART DOCUMENTS

### Patent Documents

Patent Document 1: Specification of US Patent Application Laid-Open No. 2008/0258991 (e.g., FIG. 6A)
Patent Document 2: JP-A-2008-278219 (FIG. 1)
Patent Document 3: Specification of US Patent Application Laid-Open No. 2009/0174611 (FIG. 9)

### Non-Patent Document

Non-Patent Document 1: “Decoupling and descattering networks for antennas,” IEEE Transactions on Antennas and Propagation, Vol. 24, Issue 6, November 1976

### DISCLOSURE OF THE INVENTION

### Problem that the Invention is to Solve

However, in the related-art configurations described in connection with Patent Document 1 and Non-Patent Document 1 shown in FIG. 13, a connection element 606 operates so as to generate a current distribution that is opposite in phase to a phase of coupling between elements. Accordingly, the configurations intrinsically entail a problem of a narrow band. For this reason, in order to cause the configurations to cope with multiple bands required for a current communication cellular antenna system, it is necessary to provide a plurality of antenna elements and connection elements for respective frequencies and feed power to the respective elements, which makes the configurations complicate.

The related-art configurations described in connection with Patent Document 2 and Patent Document 3 illustrate configurations intended for causing multiple resonance by introducing passive elements in order to cope with multiple bands. However, the patent documents do not include a disclosure of a method for coping with multiple bands while implementing a low coupling. The configurations cannot cope with an arrayed antenna using the same frequency, like MIMO.

The present invention is directed toward a mobile terminal including two or more antenna elements intended for copying with MIMO, or the like, and arranged in an arrayed pattern. In order to solve the aforementioned problems, there is adopted a configuration in which passive elements to be connected to an enclosure GND in close proximity to respective antenna elements are arranged and where the passive elements as well as the antenna elements are connected together by means of the connection circuit. A frequency band of the antenna elements and a frequency band of the passive elements can thereby be independently adjusted in the form of a low coupling. Hence, there are provided an arrayed antenna capable of realizing a low coupling at arbitrary two frequencies and a wireless mobile terminal equipped with the arrayed antenna.

### Means for Solving the Problem

An antenna of the present invention includes an enclosure; a circuit board that is set in the enclosure and that has a ground pattern; a first antenna element formed from conductive metal; a second antenna element formed from conductive metal; a first passive element formed from conductive metal; a second passive element formed from conductive metal; a first connection circuit for electrically connecting the first antenna element to the second antenna element; and a second connection circuit that electrically connects the first passive element to the second passive element, wherein the first antenna element and the second antenna element are placed in close proximity to each other while separated at predetermined distance apart from the ground pattern on the circuit board and electrically connected to a first feeding section and a second feeding section placed at ends of the circuit board; wherein the first passive element is placed in proximity to and substantially in parallel to the first antenna element and is electrically connected to the ground pattern on the circuit board; wherein the second passive element is placed in proximity to and substantially in parallel to the second antenna element and is electrically connected to the ground pattern on the circuit board; wherein the first connection circuit is controlled so as to cancel mutual coupling impedance existing between the first antenna element and the second antenna element at a first frequency band; and wherein the second connection circuit is controlled so as to cancel mutual coupling impedance existing between the first passive element and the second passive element at a second frequency band.

By means of the configuration, it is possible to realize an arrayed antenna that can effect low coupling at arbitrary two frequencies.

In the antenna of the present invention, the first antenna element is electrically connected to the first feeding section by way of a first reactance control circuit, and the second antenna element is electrically connected to the second feeding section by way of a second reactance control circuit.

By means of the configuration, there can be realized a lower-coupling antenna characteristic with higher efficiency at the first frequency band.

In the antenna of the present invention, the first passive element is electrically connected to the ground pattern on the circuit board by way of a third reactance control circuit, and the second passive element is electrically connected to the ground pattern on the circuit board by way of a fourth reactance control circuit.

By means of the configuration, there can be realized a lower-coupling antenna characteristic with higher efficiency at the second frequency band.

In the antenna of the present invention, any one or all of the first antenna element, the second antenna element, the first passive element, and the second passive element are formed from a copper foil on a printed board.

By means of the configuration, the antenna elements and the passive elements can be positioned with high accuracy, and a highly-productive arrayed antenna can be realized.

In the antenna of the present invention, the first antenna element, the second antenna element, the first passive element, and the second passive element are placed substantially orthogonally on the circuit board and placed in the enclosure while being bent along an interior wall of the enclosure.

By means of the configuration, a low-coupling antenna characteristic can be realized while miniaturization of the antenna is pursued.

The antenna of the present invention is implemented in a wireless mobile terminal.

By means of the configuration, an antenna characteristic of the wireless mobile terminal can be enhanced, so that miniaturization of the wireless mobile terminal can be pursued.

The antenna of the present invention is configured so as to be implemented in a wireless mobile terminal compatible with MIMO.

By means of the configuration, the antenna characteristic of the wireless mobile terminal compatible with MIMO can be enhanced, and the wireless mobile terminal can be miniaturized.

### ADVANTAGES OF THE INVENTION

The antenna of the present invention and the wireless mobile terminal equipped with the same enable realization of a low-coupling MIMO arrayed antenna that operates at arbitrary two frequencies.

### BRIEF DESCRIPTION OF THE DRAWINGS

FIG. 1 is a configuration diagram of a wireless mobile terminal of a first embodiment of the present invention.

FIG. 2 (a) is a diagram showing an example (a capacitor) of a specific configuration of a first connection circuit or a second connection circuit of the first embodiment of the present invention, FIG. 2 (b) is a diagram showing another example (an inductor) of the specific configuration of the first connection circuit or the second connection circuit of the first embodiment of the present invention, FIG. 2(c) is a diagram showing still another example (a parallel resonance circuit) of the specific configuration of the first connection circuit or the second connection circuit of the first embodiment of the present invention, FIG. 2(d) is a diagram showing yet another example (a serial resonance circuit) of the specific configuration of the first connection circuit or the second connection circuit of the first embodiment of the present invention, and FIG. 2(e) is a diagram showing a further example (a meandering pattern) of the specific configuration of the first connection circuit or the second connection circuit of the first embodiment of the present invention.

FIG. 3 is a configuration diagram of a wireless mobile terminal of a second embodiment of the present invention.

FIG. 4 (a) is a diagram showing an example of a specific configuration of a first reactance control circuit or a second reactance control circuit of the second embodiment of the present invention, and FIG. 4(b) is a diagram showing another example of the specific configuration of the first reactance control circuit or the second reactance control circuit of the second embodiment of the present invention.

FIG. 5 (a) is a diagram showing an example of a specific configuration of a third reactance control circuit or a fourth reactance control circuit of the second embodiment of the present invention, and FIG. 5(b) is a diagram showing another example of the specific configuration of the third reactance control circuit or the fourth reactance control circuit of the second embodiment of the present invention.

FIG. 6 (a) is a diagram showing a model for analysis of a characteristic of the wireless mobile terminal of the second embodiment of the present invention, and FIG. 6 (b) is a diagram showing a circuit configuration of the model for analysis of the characteristic of the wireless mobile terminal of the second embodiment of the present invention.

FIG. 7 (a) is a current distribution (2.5 GHz) chart of the wireless mobile terminal of the second embodiment of the present invention, and FIG. 7 (b) is a current distribution (1.5 GHz) chart of the wireless mobile terminal of the second embodiment of the present invention.

FIG. 8 (a) is an S parameter (S11) characteristic graph of the wireless mobile terminal of the second embodiment of the present invention, and FIG. 8(b) is an S parameter (S21) characteristic graph of the wireless mobile terminal of the second embodiment of the present invention.

FIG. 9 (a) is a radiation directivity (2.5 GHz) diagram of the wireless mobile terminal of the second embodiment of the present invention, and FIG. 9 (b) is a radiation directivity (1.5 GHz) diagram of the wireless mobile terminal of the second embodiment of the present invention.

FIG. 10 is a configuration diagram of a wireless mobile terminal of a third embodiment of the present invention.

FIG. 11 is a configuration diagram of a wireless mobile terminal of a fourth embodiment of the present invention.

FIG. 12 is a configuration diagram of a wireless mobile terminal of a fifth embodiment of the present invention.

FIG. 13 is a configuration diagram of a related-art low-coupling arrayed antenna.

### EMBODIMENTS FOR IMPLEMENTING THE INVENTION

Embodiments of the present invention are hereunder described by reference to the drawings.

### First Embodiment

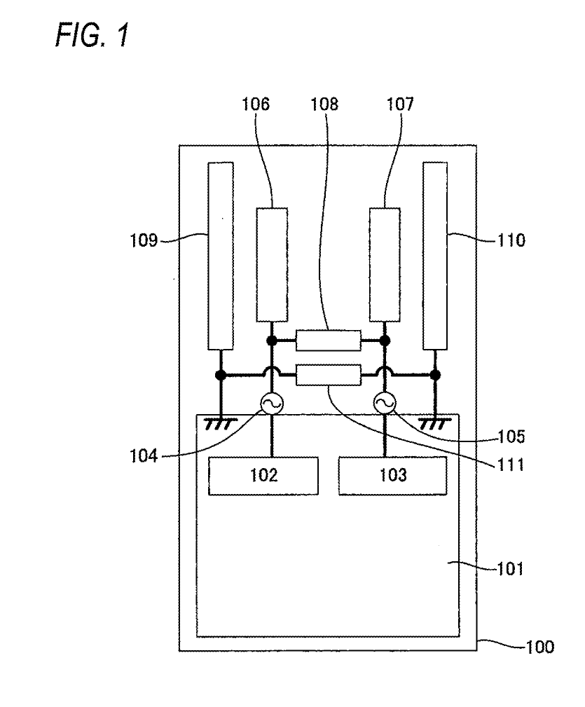

FIG. 1 is a configuration diagram of a wireless mobile terminal of a first embodiment of the present invention.

As shown in FIG. 1, a first wireless circuit section 102 is configured on a circuit board 101 set in a wireless mobile terminal 100. A high-frequency signal is fed to a first antenna element 106 formed from conductive metal by way of a first feeding section 104. Moreover, a second wireless circuit section 103 is configured on the circuit board 101, and a high-frequency signal is fed to a second antenna element 107 formed from conductive metal by way of a second feeding section 105.

Each of the first wireless circuit section 102 and the second wireless circuit section 103 operates on both the same first frequency band or adjoining first frequency bands used by a multi-band wireless system and the same second frequency band or adjoining second frequency bands.

Since both the first antenna element 106 and the second antenna element 107 are set in a mobile terminal, they are compact and assume a length of 0.5 waves or less with respect to a wavelength of a first frequency band. An attempt can also be made to miniaturize the first and second antenna elements to a much greater extent by use of a bent structure, or the like. Moreover, since the first antenna element 106 and the second antenna element 107 must be set in a limited interior of the terminal, they are adjacently spaced apart from each other at a distance of 0.5 wavelength or less and in a substantially-parallel layout. Therefore, mutual coupling impedance occurs between the antenna elements, and the high-frequency current flows into one of the antenna elements flowing into the remaining antenna element as an induction current. This resultantly deteriorates radiation performance of the antenna.

Accordingly, there is employed means for inserting a first connection circuit 108 so as to connect a neighborhood of a feeding section of the first antenna element 106 to a neighborhood of a feeding section of the second antenna element 107 and to thus cancel mutual coupling impedance of the first frequency band existing between the antennas, thereby easing deterioration of the coupling between the antenna elements.

Further, in the configuration shown in FIG. 1, a first passive element 109 formed from conductive metal is placed in proximity to the first antenna element 106, and a second passive element 110 formed from conductive metal is placed in proximity to the second antenna element 107. The antenna element and its corresponding passive element are placed in close proximity to each other at a distance of 0.25λ or less in the case of the second frequency band. Each of the first passive element 109 and the second passive element 110 assumes a length of about 0.25 half waves in the case of the second frequency band and is connected to a ground pattern of the circuit board 101. As a result of the passive elements, each having a length of about 0.25 half waves being connected to the ground pattern, a high-frequency current is induced in the passive elements from the antenna element via the ground pattern, whereby the passive elements work as radiation elements for the second frequency band. More specifically, the first passive element 109 acts as a radiation element for a second frequency band. Similarly, as a result of the second passive element being placed substantially in parallel with the second antenna element 107, mutual coupling occurs between them, and the second passive element acts as a radiation element for the second frequency band. Each of the high-frequency signals of the second frequency band induced in the first passive element 109 and the high-frequency signal of the second frequency band induced in the second passive element 110 are at the same frequency band or adjoining frequency bands. For these reasons, coupling deterioration will occur, which will in turn deteriorate the radiation characteristic of the antenna.

Accordingly, in the configuration shown in FIG. 1, the first passive element 109 and the second passive element 110 are connected together by means of a second connection circuit 111, thereby canceling mutual coupling impedance between the passive elements. Thus, deterioration of the coupling between the passive elements is improved. The second connection circuit 111 is spaced apart from the ground pattern of the circuit board 101 at a predetermined distance, thereby enabling occurrence of a high-frequency current whose potential is different from that of the ground pattern.

In connection with the configuration shown in FIG. 1, the first antenna element 106, the second antenna element 107, the first passive element 109, and the second passive element 110 are described as conductive metal components. However, even when they are formed from a copper foil pattern laid over a printed board, a similar advantage will be yielded.

In the configuration shown in FIG. 1, one passive element is placed for each antenna element. However, there may also be adopted a configuration where two passive elements or more are placed for each antenna element and connected together by means of a connection circuit so as to cope with three frequency bands or more.

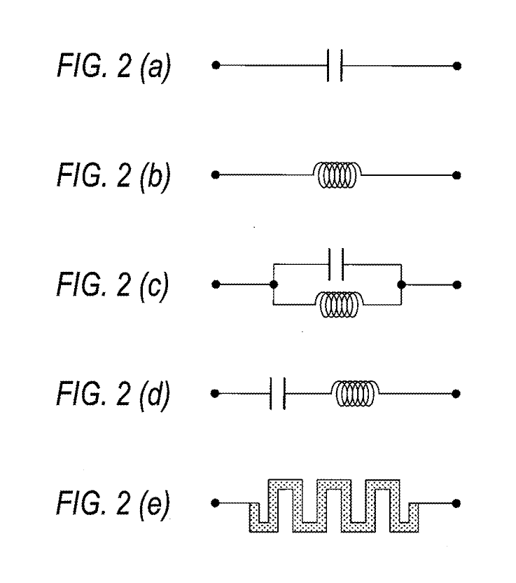

FIG. 2(a) to FIG. 2(e) are diagrams showing a specific configuration of the first connection circuit or the second connection circuit of the first embodiment of the present invention.

As shown in FIG. 2(a) to FIG. 2(e), each of the first connection circuit and the second connection circuit can be configured in the form of (a) a capacitor, (b) an inductor, (c) a parallel resonance circuit, (d) a serial resonance circuit, and (e) a meandering pattern. The first connection circuit and the second connection circuit can also be embodied in a configuration, like a filter and a capacitor formed from a pattern, so long as an equivalent circuit of the configuration can be expressed by a combination of a capacitor and an inductor other than those mentioned above and so long as mutual coupling impedance of the configuration can be controlled. In addition, a configuration that is a combination of any of the above-mentioned configurations can also be adopted.

As mentioned above, according to the first embodiment, it is possible to lessen coupling deterioration occurring at any of the first frequency band at which the first antenna element 106 and the second antenna element 107 are put in operation and the second frequency band at which the first passive element 109 and the second passive element 110 are put in operation. Thus, a low-coupling, high-gain built-in arrayed antenna can be configured. The present technique makes it possible to realize a MIMO arrayed antenna that operates at two frequency bands or more.

### Second Embodiment

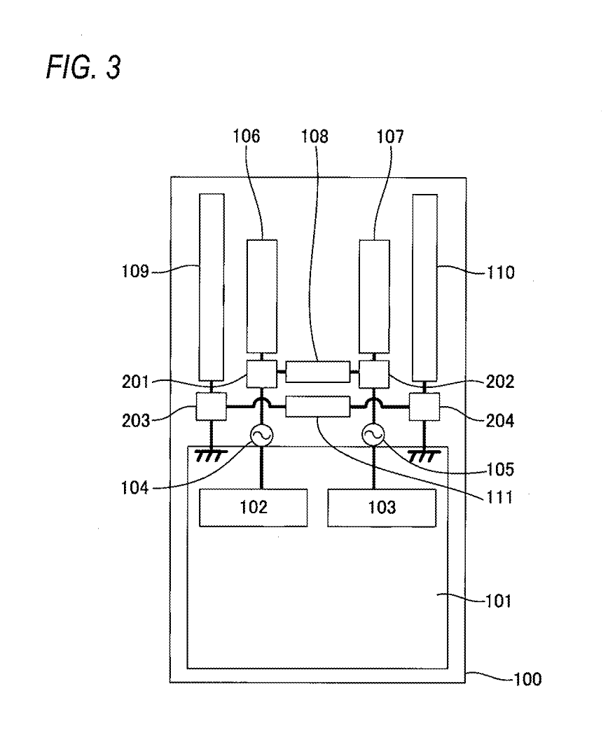

FIG. 3 is a configuration diagram of a wireless mobile terminal of a second embodiment of the present invention.

In FIG. 3, the same elements as those shown in FIG. 1 are assigned the same reference numerals, and their repeated explanations are omitted.

As shown in FIG. 3, the first antenna element 106 is connected to the first feeding section 104 by way of a first reactance control circuit 201. The second antenna element 107 is connected to the second feeding section 105 by way of a second reactance control circuit 202.

Moreover, the first passive element 109 is connected to the ground pattern of the circuit board 101 by way of a third reactance control circuit 203. The second passive element 110 is connected to the ground pattern of the circuit board 101 by way of a fourth reactance control circuit 204.

The first reactance control circuit 201 and the second reactance control circuit 202 are placed, thereby making it possible to control, in a more elaborate manner, mutual coupling impedance between the first antenna element 106 and the second antenna element 107 at the first frequency band. An effect of lessening coupling deterioration is further enhanced.

Moreover, the third reactance control circuit 203 and the fourth reactance control circuit 204 are placed, thereby making it possible to control, in a more elaborate manner, mutual coupling impedance between the first passive element 109 and the second passive element 110 at the second frequency band. An effect of lessening coupling deterioration is further enhanced.

In the configuration shown in FIG. 1 or FIG. 3, mutual coupling of various types occurs among a total of four elements consisting of the two antenna elements and the two passive elements. However, placing the reactance control circuits makes it possible to control mutual coupling impedance comprehensively. As a consequence, S12 and S21 that are pass characteristics existing between the first feeding section 104 and the second feeding section 105 can be suppressed low even at the frequency bands; namely, both the first frequency band and the second frequency band, so that coupling deterioration can be lessened.

In the configuration shown in FIG. 3, the total of four reactance control circuits are set. However, there can also be adopted a configuration where the reactance control circuits are provided only for the antenna elements or the passive elements and where mutual coupling impedance is controlled by controlling the connection circuits.

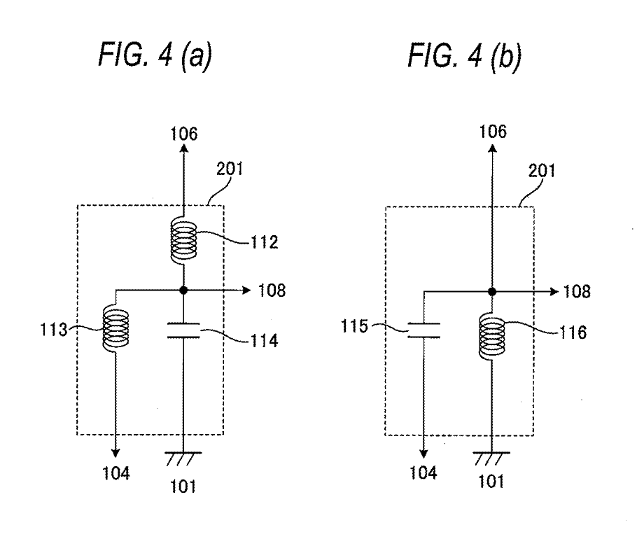

FIG. 4(a) and FIG. 4(b) are diagrams showing a specific configuration of the first reactance control circuit 201 or the second reactance control circuit 202 of the second embodiment of the present invention. In FIGS. 4(a) and 4(b), the first reactance control circuit 201 is described as being intended for use with the first antenna element 106. However, since the reactance control circuit 202 for the second antenna element 107 can also be explained by use of the similar configurations, its explanation is omitted here for brevity.

As shown in FIG. 4(a) and FIG. 4(b), a plurality of capacitors or inductors can be configured within each of the reactance control circuits. It is also possible to employ a configuration where a capacitor or an inductor is positioned for use with the antenna element and the feeding section, respectively.

In FIG. 4(a), an inductor 112 is placed for use with the first antenna element 106, and an inductor 113 is placed for use with the first feeding section 104. One end of a capacitor 114 is connected to a junction between the inductor 113 and the first connection circuit 108. The other end of the capacitor 114 is connected to a ground pattern of the circuit board 101. It is preferable that a location where the capacitor 114 is connected to the ground pattern should be as close as possible to the first feeding section 104. Loading the inductor 112 into the first reactance control circuit is electrically equivalent to lengthening the first antenna element 106. Accordingly, another possible configuration is that the inductor for the antenna element is deleted as shown in FIG. 4(b) and that a similar function is implemented by controlling the length of the antenna element.

In FIG. 4(b), a capacitor 115 is connected to the first feeding section 104. One end of an inductor 116 is connected to a junction between the capacitor 115 and the first connection circuit 108, and the other end of the inductor 116 is connected to a ground pattern of the circuit board. It is also possible to provide the inductor 113 and the capacitor 114 or the capacitor 115 and the inductor 116 with the function of acting as an impedance matching circuit for the first antenna element 106. Further, S12 and S21 that are pass characteristics existing between the first feeding section 104 and the second feeding section 105 at the first frequency band can be suppressed low, and S11 that is impedance of the first antenna element 106 when viewed from the first feeding section 104 can also be suppressed low.

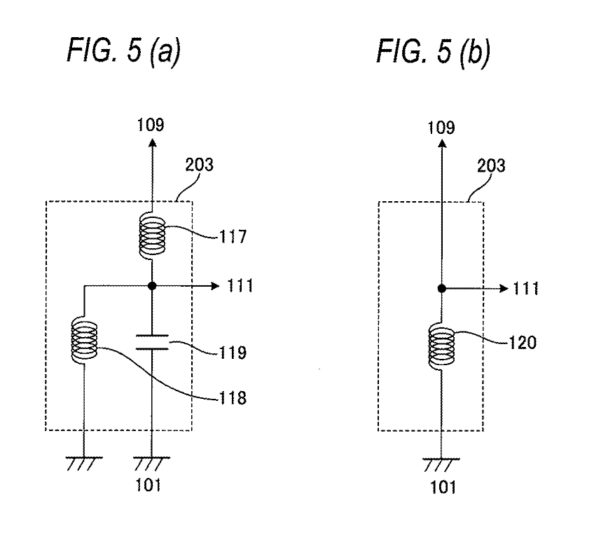

FIG. 5(a) and FIG. 5(b) are diagrams showing a specific configuration of the third reactance control circuit 203 or the fourth reactance control circuit 204 of the second embodiment of the present invention. In FIGS. 5(a) and 5(b), the third reactance control circuit 203 is described as being intended for use with the first passive element 109. However, the fourth reactance control circuit 204 intended for use with the second passive element 110 can also be explained as a similar configuration, and hence its repeated explanations are omitted here.

As shown in FIG. 5(a) and FIG. 5(b), a plurality of capacitors or inductors can be implemented in the reactance control circuit. It is also possible to employ a configuration where a capacitor or an inductor is placed for use with the antenna element and the ground, respectively.

In FIG. 5(a), an inductor 117 is placed for use with the first passive element 109, and one end of an inductor 118 and one end of a capacitor 119 are connected to a junction between the inductor 117 and the second connection circuit 111. The other end of the inductor 118 and the other end of the capacitor 119 are connected to the ground pattern of the circuit board 101. It is preferable that the connections of the inductor 118 and the capacitor 119 with the ground pattern be as close as possible to the first feeding section 104. Since the inductor 117 is electrically equivalent to lengthening the first passive element 109, the inductor for the passive element is deleted as shown in FIG. 5(b). A similar function can be implemented by control of the length of the passive element.

In FIG. 5(b), grounding effected by way of the ground pattern of the circuit board 101 is controlled by means of only an inductor 120. It is also possible to provide the inductor 117 and the capacitor 119 or the inductor 120 with the function of acting as an impedance matching circuit for the ground point of the first passive element 109. Accordingly, S12 and S21 that are the pass characteristics existing between the first feeding section 104 and the second feeding section 105 at the second frequency band can be suppressed low, and S11 that is the impedance of the first antenna element 106 when viewed from the first feeding section 104 can also be suppressed.

Subsequently, a case of performance analysis is illustrated in connection with a more specific configuration shown in FIG. 3.

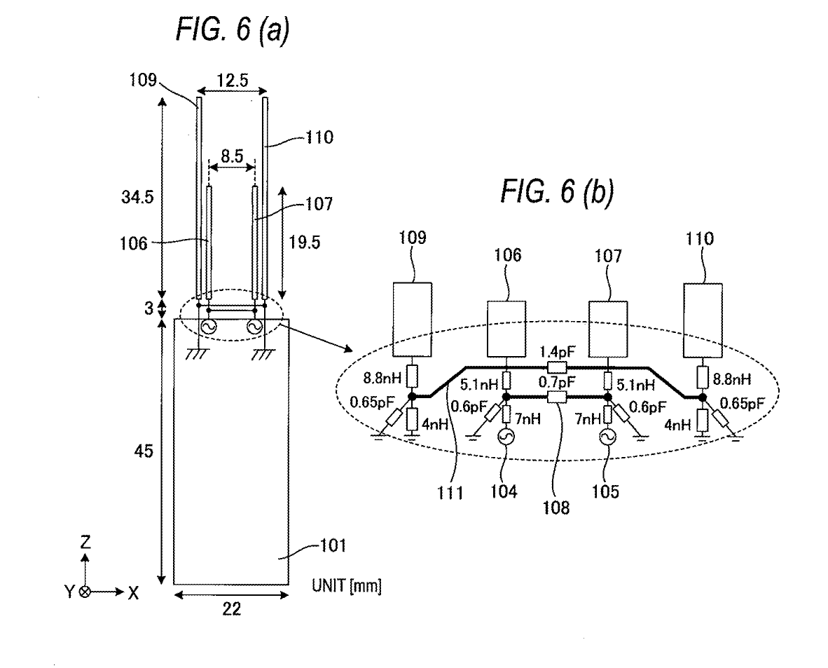

FIG. 6(a) is a diagram showing a model for analysis of a characteristic of the wireless mobile terminal of the second embodiment of the present invention. FIG. 6(b) is a diagram showing a circuit configuration of a model for analysis of the characteristic of the wireless mobile terminal of the second embodiment of the present invention.

As shown in FIG. 6(a), the circuit board 101 is formed from a printed board made of a glass epoxy resin, or the like. The circuit board 101 is modeled as being formed from a copper foil having a length of 45 mm and a width of 22 mm and subjected to analysis. In the circuit board 101, a high-frequency signal is fed, by way of the first feeding section 104 and the second feeding section 105, to both the first antenna element 106 and the second antenna element 107 that are formed from a conductive copper foil pattern. Moreover, the first passive element 109 that is a conductive copper foil pattern is placed in close proximity to the first antenna element 106, and the second passive element 110 that is a conductive copper foil pattern is placed in close proximity to the second antenna element 107.

The first feeding section 104 feeds a high-frequency signal which ranges from 1 GHz to 3 GHz and which includes a 2.5 GHz high-frequency signal corresponding to the first frequency band and a 1.5 GHz high-frequency signal corresponding to the second frequency band. The pass characteristic S21 and the reflection characteristic 511 that are S parameters, a current distribution, and a radiation characteristic are subjected to analysis.

The first antenna element 106 and the second antenna element 107 each have a length of 19.5 mm and a width of 1 mm and are separated from the ground pattern by a distance of 3 mm. A length of a 22.5-mm-long antenna, including a 3-mm-long connection path from the feeding section, is equivalent to a length of a 0.187 wavelength with respect to a 120-mm length of the 2.5 GHz wavelength. Spacing between the first antenna element 106 and the second antenna element 107 is 8.5 mm. The first antenna element and the second antenna element are positioned substantially in parallel with each other at spacing that is extremely close to a 0.07 wavelength at 2.5 GHz. Since the first antenna element 106 and the second antenna element 107 are positioned substantially in parallel with each other at an electrically close distance, mutual coupling occurs between the antenna elements. As a result of the high-frequency current flowed into the respective antenna elements flowing into their counterparts as an induction current, radiation performance of the antenna is eventually deteriorated.

Accordingly, the first connection circuit 108 for connecting the first antenna element 106 and the second antenna element 107 together is inserted into a line connected to respective lower ends of the first and second antenna elements, thereby canceling mutual coupling impedance existing between the antenna elements at 2.5 GHz. Thus, coupling deterioration occurring between the antenna elements is lessened.

In FIG. 6(a), the first connection circuit 108 is spaced apart from the ground pattern by 2 mm. Moreover, the first reactance control circuit 201 is positioned at a root of the first antenna element 106, and the second reactance control circuit 202 is positioned at a root of the second antenna element 107, thereby making it possible to control mutual coupling impedance existing between the first antenna element 106 and the second antenna element 107 more elaborately. Thus, an effect of lessening coupling deterioration can be further enhanced.

As shown in FIG. 6(b), the first connection circuit 108 is formed from a connection path having a length of 8.5 mm, and a 0.7-pF capacitor is placed at the center of the first connection circuit 108. Further, a 5.1-nH inductor is implemented on the first reactance control circuit 201 so as to be connected to the first antenna element 106. Further, a 7-nH inductor is implemented on the first reactance control circuit 201 so as to be connected to the first feeding section 104. Further, the first reactance control circuit 201 is connected to the ground pattern of the circuit board by way of a 0.6-pF capacitor. The second reactance control circuit 202 is configured so as to be symmetrical to the first reactance control circuit 201.

Explanations are now given to a configuration of the passive element for activating the antenna at the 1.5-GHz band corresponding to the second frequency band.

The first passive element 109 and the second passive element 110 each have a length of 34.5 mm and a width of 1 mm and are separated from the ground pattern by 3 mm. A length of the 37.5-mm-long passive element, including a 3-mm-long connection path from the ground pattern, is equivalent to the length of the 0.187 wavelength with respect to a length of 200 mm that is a 1.5 GHz wavelength. The first passive element 109 is closely positioned in parallel with the first antenna element 106 at spacing of 2 mm. The second passive element 110 is closely positioned in parallel with the second antenna element 107 at spacing of 2 mm. The passive element having a length of 0.187 wavelength at 1.5 GHz is connected to the ground pattern, whereby the high-frequency current is induced in the passive element by the antenna element by way of the ground pattern. As a result, the passive element acts as a 1.5 GHz radiation element. When positioned substantially in parallel with the first antenna element 106, the first passive element 109 is subjected to coupling, to thus act as a 1.5-GHz radiation element.

Likewise, when placed substantially in parallel with the second antenna element 107, the second passive element 110 is subjected to coupling, to thus act as the 1.5-GHz radiation element. Both the high-frequency signal induced in the first passive element 109 and the high-frequency signal induced in the second passive element 110 are at the same 1.5 GHz band. The passive elements are spaced apart from each other by 12.5 mm. Thus, the first passive element and the second passive element are placed at spacing that is extremely close to a 0.06 wavelength achieved at 1.5 GHz. Hence, coupling deterioration occurs, to thus deteriorate the radiation characteristic.

Accordingly, the first passive element 109 and the second passive element 110 are connected by means of the second connection circuit 111, thereby canceling mutual coupling impedance existing between the passive elements. Thus, coupling deterioration occurring between the passive elements is lessened.

In FIG. 6(a), the second connection circuit 111 is spaced apart from the ground pattern by 2 mm. As a result of the second connection circuit 111 being spaced apart from the ground pattern, a high-frequency current whose potential differs from that of the ground pattern flows into the second connection circuit 111, thereby lessening the coupling deterioration occurring between the passive elements. Moreover, the third reactance control circuit 203 is positioned at a root of the first passive element 109, and the fourth reactance control circuit 204 is positioned at a root of the second passive element 110. This makes it possible to control, in a more elaborate manner, mutual coupling impedance existing between the first passive element 109 and the second passive element 110 at 1.5 GHz. An effect of lessening coupling deterioration is enhanced further.

As shown in FIG. 6(b), the second connection circuit 111 is formed from a connection path having a length of 12.5 mm. A 1.5-pF capacitor is placed at the center of the second connection circuit. Moreover, an 8.8-nH inductor is implemented on the third reactance control circuit 203 so as to be connected to the first passive element 109. Further, the third reactance control circuit 203 is connected to the ground pattern of the circuit board by way of a 0.65-pF capacitor and a 4-nH inductor. The fourth reactance control circuit 204 is symmetrical to the third reactance control circuit 203.

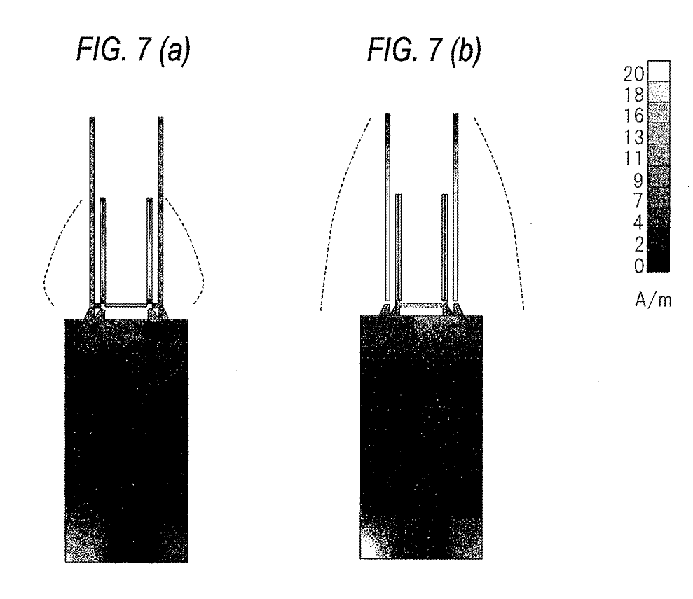

FIG. 7(a) and FIG. 7(b) are current distribution charts of the second embodiment of the present invention acquired when a current distribution waveform is analyzed by use of the analysis model shown in FIG. 6(a).

FIG. 7(a) is a current distribution waveform acquired when the first antenna element 106 is excited at 2.5 GHz, and FIG. 7(b) is a current distribution waveform acquired when the first antenna element 106 is excited at 1.5 GHz. The first antenna element 106 is an element on the left side of the drawing when viewing the drawing from the front.

As shown in FIG. 7(a), the current distribution appearing at 2.5 GHz is concentrated on the first antenna element 106 and the second antenna element 107. As indicated by a broken line, the current distribution becomes minimum at a leading end of the antenna element and maximum at the feeding end of the same. The distribution corresponds to a geometry of a current distribution of a 0.25-wavelength monopole antenna. Although a substantially-equal high-frequency current also flows into the ground pattern, small current density is observed, because the ground pattern serving as an element for letting the electric current flow has a wide area.

The electric current flowing into the second antenna element 107 is a vector synthesis consisting of an electric current spatially coupled and induced by the first antenna element 106 and an electric current given by the first feeding section 104 via the first connection circuit 108. Although the electric current flowing into the first antenna element 106 and the electric current flowing into the second antenna element 107 have substantially the same amplitude, they are opposite in phase to each other. When the first feeding section 104 is excited, the amount of electric currents flowing around the second feeding section 105 becomes smaller. This shows that coupling deterioration is lessened.

As shown in FIG. 7(b), the current distribution appearing at 1.5 GHz is concentrated on the first passive element 109 and the second passive element 110. As indicated by a broken line, the current distribution becomes minimum at a leading end of the passive element and maximum at a grounding end of the same. The distribution corresponds to a geometry of a current distribution of a 0.25-wavelength monopole antenna. Although a substantially-equal high-frequency current also flows into the ground pattern, small current density is observed, because the ground pattern serving as an element for letting the electric current flow has a wide area. The electric current flowing into the second passive element 110 is a vector synthesis consisting of an electric current spatially coupled and induced by the first antenna element 106 via the first passive element 109 and an electric current given by the ground pattern of the circuit board 101 via the second connection circuit 111. Although the electric current flowing into the first passive element 109 and the electric current flowing into the second passive element 110 have substantially the same amplitude, they are opposite in phase to each other.

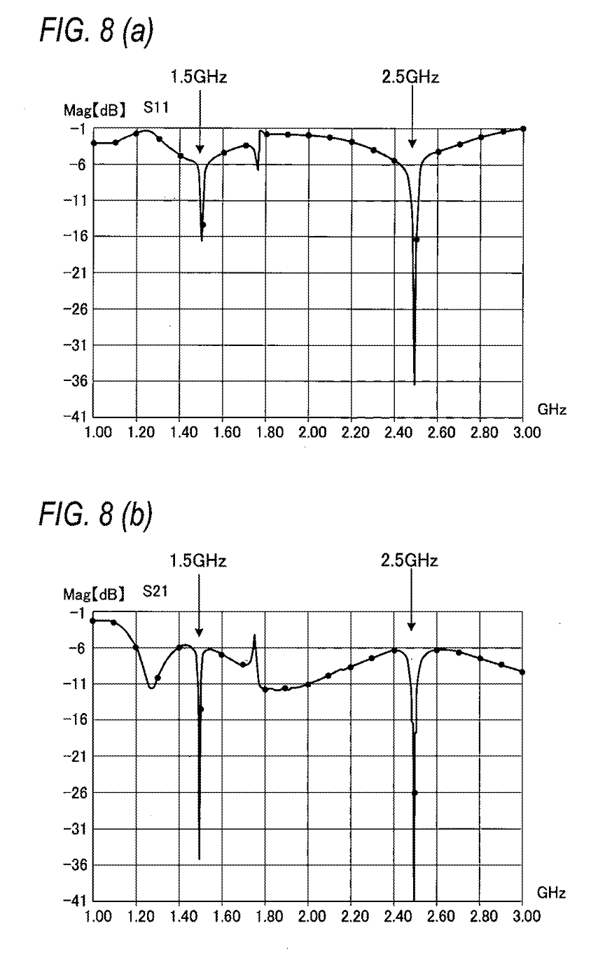

FIG. 8(a) and FIG. 8(b) are S parameter characteristic graphs for the second embodiment of the present invention acquired through analysis by use of the analysis model shown in FIG. 6(a). FIG. 8(a) shows an S11 waveform when viewed from the first feeding section 104, and FIG. 8(b) shows an S21 waveform that is a pass characteristic acquired when the electric current flows from the first feeding section 104 toward the second feeding section 105. In each of the graphs, a horizontal axis represents a frequency characteristic ranging from 1 GHz to 3 GHz. Since FIG. 6(b) is bilaterally symmetric, it is well known that the S22 waveform viewed from the second feeding section 105 and the S12 waveform that is a pass characteristic achieved when an electric current flows from the second feeding section 105 to the first feeding section 104 assume the same characteristics. Therefore, their repeated explanations are omitted here.

As shown in FIG. 8(a), S11 acquired at 1.5 GHz and 2.5 GHz assumes a low value that is −10 dB or less. This shows that impedance matching is achieved at this frequency band. Further, as shown in FIG. 8(b), the S21 waveform that is a pass characteristic achieved at 1.5 GHz and 2.5 GHz assumes a low value of −10 dB or less. This shows that isolation is assured at the frequency band and that coupling deterioration is lessened. As mentioned above, it is seen that impedance matching and isolation can be assured at both the 1.5-GHz frequency band the 2.5-GHz frequency band and that coupling deterioration is lessened.

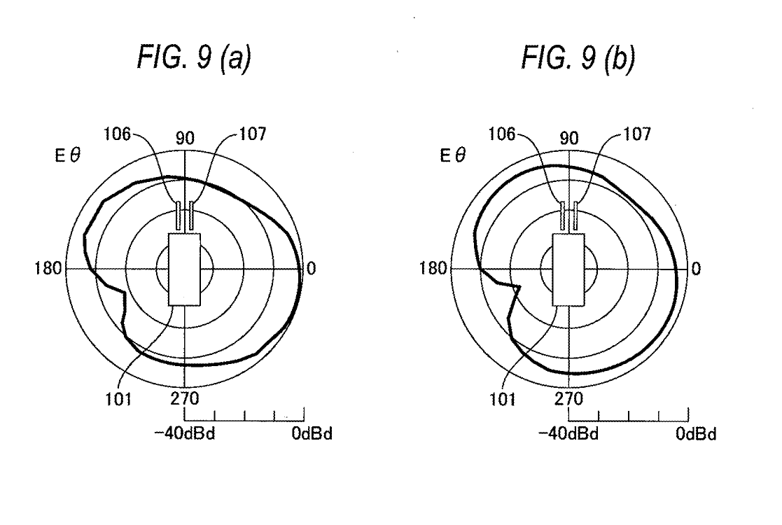

FIG. 9(a) and FIG. 9(b) are radiation directivity diagram of an XZ-plane Eθ component of the second embodiment of the present invention analyzed by use of the analysis model shown in FIG. 6(a). FIG. 9(a) shows radiation directivity achieved when the first antenna element 106 is excited at 2.5 GHz. FIG. 9(b) shows radiation directivity achieved when the first antenna element 106 is excited at 1.5 GHz. The first antenna element 106 is a left-side element, and the second antenna element 107 is a right-side element. A horizontal axis represents a gain dBd of a dipole ratio standardized by means of a directivity gain of a dipole antenna. The horizontal axis shows a maximum of 0 dBd and a minimum of −40 dBd.

As shown in FIG. 9(a), a directivity pattern of the XZ-plane Eθ component becomes bilaterally asymmetric about a Z axis. Directivity becomes intensive particularly in a neighborhood of θ=135° where a power-fed antenna element is placed and a neighborhood of θ=0° where radiation from the ground pattern becomes dominant. On the contrary, it is seen that directivity becomes low in a neighborhood of θ=45° and a neighborhood of θ=180°.

FIG. 9(a) shows radiation directivity achieved when the left-side first antenna element 106 is excited. However, when the right-side second antenna element 107 is excited, the radiation directivity becomes bilaterally symmetric. Accordingly, it is understood that a directivity pattern of the first antenna element 106 and a directivity pattern of the second antenna element 107 exhibit high gains in opposite directions. Therefore, a spatial correlation coefficient calculated from the directivity pattern is suppressed to a value of 0.5 or less, whereby deterioration of an MIMO characteristic due to mutual coupling is lessened. Further, a directivity gain is a value substantially close to 0 dBd, so that a highly-efficient antenna can be implemented.

A similar directivity pattern is also plotted even in FIG. 9(b). High directivity appears in a neighborhood of θ=135° at 1.5 GHz where the passive element is in operation and a neighborhood of θ=0° where radiation from the ground pattern becomes dominant. On the contrary, low directivity appears in a neighborhood of θ=45° and a neighborhood of θ=180°.

In FIG. 9(b), radiation directivity is one that is acquired when the left-side first passive element 109 is in operation. When the right-side second passive element 110 is in operation, the radiation directivity becomes bilaterally symmetric. Hence, it is understood that the directivity pattern of the first passive element 109 and the directivity pattern of the second passive element 110 exhibit high gains in opposite directions. For these reasons, the spatial correlation coefficient calculated from the directivity patterns is suppressed to a value of 0.5 or less, whereby deterioration of the MIMO characteristics due to mutual coupling is lessened. Moreover, the directivity gain has come to a value of about −2 dBd, so that a highly-efficient antenna can be implemented.

Although unillustrated, a figure-of-eight bilaterally symmetric directivity pattern appears at frequency bands other than the 1.5-GHz and 2.5-GHz frequency bands. Since the spatially correlation coefficient has already become high, the frequency bands have become inappropriate for use with the MIMO antenna.

As mentioned above, according to the second embodiment, a lessening of coupling deterioration can be achieved at both the first frequency band where the first antenna element 106 and the second antenna element 107 are put in operation and the second frequency band where the first passive element 109 and the second passive element 110 are used while being actuated. Thus, a high-gain built-in arrayed antenna can be constructed by means of low coupling. According to the present technique, a terminal arrayed antenna that operates at two arbitrary frequency bands or more can be realized by controlling the reactance control circuits and without involvement of fine adjustment of the lengths of the antenna elements.

### Third Embodiment

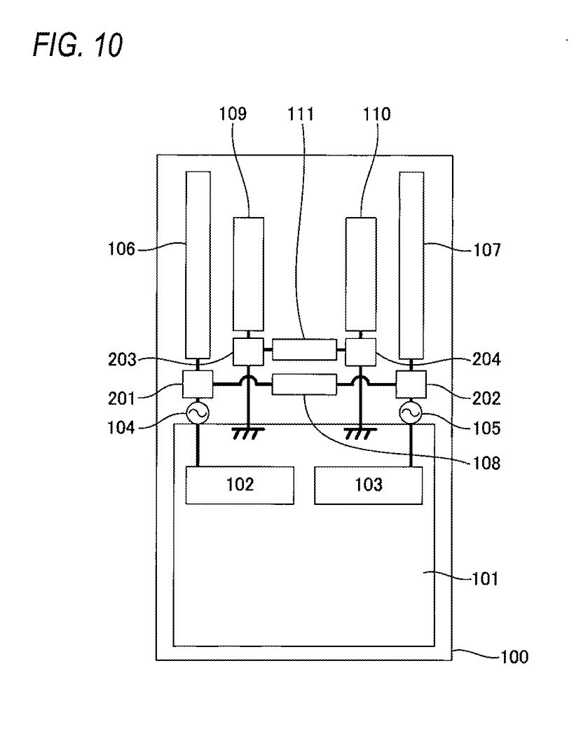

FIG. 10 is a configuration diagram of a wireless mobile terminal of a third embodiment of the present invention.

In FIG. 10, the same reference numerals are assigned to the same elements as those used in the configuration shown in FIG. 3, and their repeated explanations are omitted.

In FIG. 3, the first passive element 109 and the second passive element 110 are placed outside the first antenna element 106 and the second antenna element 107. In FIG. 10, the first passive element 109 and the second passive element 110 are placed between the first antenna element 106 and the second antenna element 107. In FIG. 3, the first frequency band at which the antenna elements are operated is taken as a high frequency, and the second frequency band at which the passive elements are operated is taken as a low frequency. By contrast, the first frequency band at which the antenna elements are operated is taken as a low frequency, and the second frequency band at which the passive elements are operated is taken as a high frequency. Therefore, in FIG. 10, the antenna elements are longer than the passive elements. The configuration shown in FIG. 10 can also provide substantially the same operation and performance as those provided by the configuration shown in FIG. 3 except the above-mentioned difference in configuration.

As shown in FIGS. 9(a) and 9(b), a directivity gain exhibited at the frequency band at which the antenna elements operate is higher than a directivity gain exhibited at the frequency band at which the passive elements operate. Hence, a frequency band, a characteristic of which is desired to gain greater emphasis, is used for the passive elements, whereby a characteristic balance among a plurality of frequency bands can be controlled.

### Fourth Embodiment

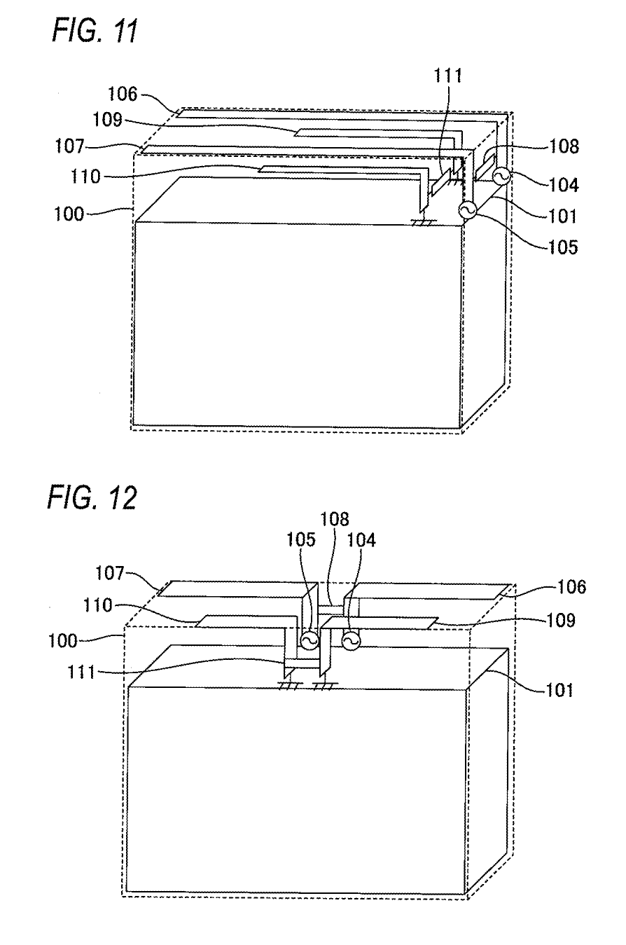

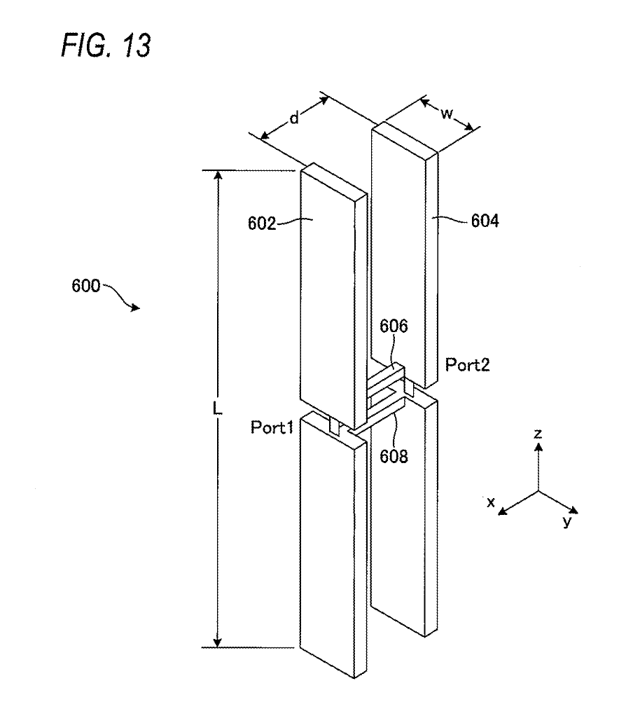

FIG. 11 is a configuration diagram of a wireless mobile terminal of a fourth embodiment of the present invention.

In FIG. 11, the same reference numerals are assigned to the same elements as those used in the configuration shown in FIG. 1 or FIG. 3, and their repeated explanations are omitted.

In FIG. 11, the first antenna element 106, the second antenna element 107, the first passive element 109, and the second passive element 110 are arranged in such a way that they stretched substantially orthogonally to the circuit board 101 and subsequently folded at right angles along an interior wall of the enclosure of the wireless mobile terminal 100. In the configuration shown in FIG. 11, the first passive element 109 is placed inside of a bend of the first antenna element 106, and the second passive element 110 is placed inside a bend of the second antenna element 107.

By adoption of the above-mentioned layout, the spacing between the antenna elements and the spacing between the passive elements are made substantially equal to each other. Moreover, the antenna elements and the passive elements can be stored with a small occupied volume and within an enclosure of the wireless terminal 100. Low-coupling antenna characteristics can be achieved while miniaturization of the antenna is being pursued. Moreover, in the configuration shown in FIG. 11, it is possible to assure the maximum physical length of the antenna elements or the passive elements with respect to a width of the wireless mobile terminal. Hence, there is yielded an advantage of the ability to assure a higher characteristic at a low frequency band.

In the configuration shown in FIG. 11, the respective passive elements are placed inside the bend of the corresponding antenna element. However, another configuration where the antenna element is placed inside a bend of the passive element can also be adopted. So long as a condition of the length of the passive elements being made equal to a length of about 0.25 half wave at the second frequency band is satisfied, either the passive elements or the antenna elements may be longer than the length of the remaining elements.

### Fifth Embodiment

FIG. 12 is a configuration diagram of a wireless mobile terminal of a fifth embodiment of the present invention.

In FIG. 12, the same reference numerals are assigned to the elements that are the same as those of the configuration shown in FIG. 1 or FIG. 3, and their repeated explanations are omitted.

In FIG. 12, the first antenna element 106 and the second antenna element 107 are laid while being bent at right angles in the form of the letter T. Namely, after being stretched substantially orthogonally to the circuit board 101, the antenna elements are split in the right and left directions along an interior wall of the enclosure of the wireless mobile terminal 100. Moreover, the first passive element 109 and the second passive element 110 are laid while being bent at right angles in the form of the letter T. Namely, after being stretched substantially orthogonally to the circuit board 101, the passive elements are split in the right and left directions along an interior wall of the enclosure of the wireless mobile terminal 100.

By adoption of such a configuration, the first antenna element 106 and the first passive element 109 are closely laid substantially in parallel to each other. Further, the second antenna element 107 and the second passive element 110 are closely laid substantially in parallel to each other. Spacing between each of the antenna elements and each of the passive element can be configured so as to be equal. Further, in the configuration shown in FIG. 12, the area where the antenna elements are closely laid in parallel to each other or where the passive elements are closely laid in parallel to each other can be shortened. Hence, a coupling lessening effect is yielded.

Accordingly, the antenna elements and the passive elements can be stored in the enclosure of the wireless terminal 100 at a small occupied volume. A low-coupling antenna characteristic can be realized while miniaturization of the antenna is being pursued. In relation to the configuration shown in FIG. 12, so long as a condition of the length of the passive elements being made equal to a length of about 0.25 half wave at the second frequency band is satisfied, either the passive elements or the antenna elements may be longer than the length of the remaining elements.

Although the present invention has been described in detail by reference to the specific embodiments, it is manifest to those skilled in the art that the present invention be susceptible to various alterations and modifications without departing the spirit and scope of the present invention.

The present patent application is based on Japanese Patent Application (JP-2010-034463) filed on Feb. 19, 2010, the entire subject matter of which is incorporated herein by reference in its entirety.

### INDUSTRIAL APPLICABILITY

The antenna of the present invention and the wireless mobile terminal equipped with the same make it possible to materialize a low-coupling arrayed antenna that operates at two arbitrary frequency bands. Hence, the present invention is useful for a wireless mobile terminal, like a cellular phone.

### DESCRIPTIONS OF THE REFERENCE NUMERALS AND SYMBOLS

100 WIRELESS MOBILE TERMINAL
101 CIRCUIT BOARD
102 FIRST WIRELESS CIRCUIT SECTION
103 SECOND WIRELESS CIRCUIT SECTION
104 FIRST FEEDING SECTION
105 SECOND FEEDING SECTION
106 FIRST ANTENNA ELEMENT
107 SECOND ANTENNA ELEMENT
108 FIRST CONNECTION CIRCUIT
109 FIRST PASSIVE ELEMENT
110 SECOND PASSIVE ELEMENT
111 SECOND CONNECTION CIRCUIT
112, 113, 116, 117, 118, 120 INDUCTOR
114, 115, 119 CAPACITOR
201 FIRST REACTANCE CONTROL CIRCUIT
202 SECOND REACTANCE CONTROL CIRCUIT
203 THIRD REACTANCE CONTROL CIRCUIT
204 FOURTH REACTANCE CONTROL CIRCUIT
606 CONNECTION ELEMENT

1. An antenna comprising:
an enclosure;
a circuit board that is set in the enclosure and that has a ground pattern;
a first antenna element formed from conductive metal;
a second antenna element formed from conductive metal;
a first passive element formed from conductive metal;
a second passive element formed from conductive metal;
a first connection circuit for electrically connecting the first antenna element to the second antenna element; and a second connection circuit that electrically connects the first passive element to the second passive element;
wherein the first antenna element and the second antenna element are placed in close proximity to each other while separated at predetermined distance apart from the ground pattern on the circuit board and electrically connected to a first feeding section and a second feeding section placed at ends of the circuit board;
wherein the first passive element is placed in proximity to and substantially in parallel to the first antenna element and is electrically connected to the ground pattern on the circuit board; wherein the second passive element is placed in proximity to and substantially in parallel to the second antenna element and is electrically connected to the ground pattern on the circuit board;
wherein the first connection circuit is controlled so as to cancel mutual coupling impedance existing between the first antenna element and the second antenna element at a first frequency band; and wherein the second connection circuit is controlled so as to cancel mutual coupling impedance existing between the first passive element and the second passive element at a second frequency band.

2. The antenna according to claim 1, wherein the first antenna element is electrically connected to the first feeding section by way of a first reactance control circuit, and the second antenna element is electrically connected to the second feeding section by way of a second reactance control circuit.

3. The antenna according to claim 1, wherein the first passive element is electrically connected to the ground pattern on the circuit board by way of a third reactance control circuit, and the second passive element is electrically connected to the ground pattern on the circuit board by way of a fourth reactance control circuit.

4. The antenna according to claim 1, wherein any one or all of the first antenna element, the second antenna element, the first passive element, and the second passive element are formed from a copper foil on a printed board.

5. The antenna according to claim 1, wherein the first antenna element, the second antenna element, the first passive element, and the second passive element are placed substantially orthogonally on the circuit board and placed in the enclosure while being bent along an interior wall of the enclosure.

6. A wireless mobile terminal in which the antenna according to claim 1 is implemented.

7. A wireless mobile terminal compatible with MIMO in which the antenna according to claim 1 is implemented.
